(19) United States
(12) Patent Application Publication
(10) Pub. No.: US 2014/0280751 A1
(43) Pub. Date: Sep. 18, 2014

(54) System and Method of Use of Interactive User Group Function for Network Devices

(71) Applicant: Sharon Jiayin Lo, Palo Alto, CA (US)

(72) Inventor: Sharon Jiayin Lo, Palo Alto, CA (US)

(21) Appl. No.: 13/831,723

(22) Filed: Mar. 15, 2013

(51) Int. Cl. H04L 29/08

(52) U.S. Cl. CPC H04L 67/1097
USPC 709/219

(57) ABSTRACT

A system and method to specify user group function interactively among network devices and provide characteristics of the specified user group from remote accessible server for user's reference without disclosing each individual own identity. The user group can be specified interactively by changing the group parameters within user group function. User could specify another new group till user is satisfied with the new characteristics of the new group. A pedometer application software running on a smart phone is given as an example to demonstrate the novel user group function.

### FIELD OF THE INVENTION

The embodiments described herein relate generally to a system and method to specify user group function interactively among network devices, in particular, to a system and method to specify user group function interactively among network devices and provide characteristics of the specified user group activity from remote accessible server for user's reference without disclosing each individual's identity.

### BACKGROUND OF THE INVENTION

Recently, mobile handsets are used not only for voice communication, but also for accessing information from internet via wireless networks. Furthermore, mobile handsets can provide data information obtained from embedded sensors, such as a motion sensor or a location sensor. The data information can be recorded and further processed for the users' reference. For example, an application software (App) can be loaded into a smart phone, such as an iPhone from Apple Co., and be used as a pedometer (www.runtastic.com). Within the pedometer App, information such as the number of walking steps, distance, calorie consumed, route, etc. of a user's walking activities can be derived from data collected by the sensor and recorded in the smart phone. The information can also be shared with friends via e-mail or within social networks. In this process, the user's identity will be disclosed. Alternatively, the information can be further uploaded to a remote server for storage and for the user's historical reference. In this manner, however, the information stored in the remote server cannot be shared with the public due to privacy reason.

Accordingly, a system and method of use of interactive user group function is desired such that a user interest group can be specified and its characteristics can be provided constantly for the user's reference.

### SUMMARY OF THE EMBODIMENTS

The embodiments provided herein are directed to a system and method to specify user group function interactively among network devices and provide characteristics of the specified user group activity constantly from remote accessible server to network device for user's reference without disclosing the identity of each individual within the specified user group. The user group can be specified interactively by changing the group parameters within user group function. User could specify another new group till user is satisfied with the new characteristics of the new group.

A pedometer App running on a smart phone is given as an example to show the novel user group function. In one embodiment, the system and method of said example can be described as: providing a network device such as a smart phone with various motion sensors such as accelerometer, gyroscope, magentometer and a locating device such as a global positioning system; providing the information of a plurality of group parameters of network device to remote server; providing the activity data of various motion sensors of network devices; providing a remote server which can be accessed through network; sending activity data from the network devices and storing the data in the remote server; specifying the user group by specifying the characteristics of group parameters among user group function and sending to remote server from network devices; characterizing the characteristics of various parameters of activity data of all users within specified user groups in the remote server; sending back from remote server to the network device the characterized result upon request or regularly; specifying new group by adjusting group parameters and sending to remote server from network device; the remote server characterizing the new group characteristics and send the new results back to network device for reference.

One advantage of the system and method in accordance with the embodiments described herein is that the user group can be interactively customized by specifying user group parameters to fit user's interest such that characterized group characteristics provides more related information to the user. A second advantage of a system and method in accordance with the embodiments described herein is the fact that the user group function provides to users a good reference of interested user group characteristics, and encourages users to take an action or motivates users to make progress within user group without disclosing their identity.

In order to facilitate an understanding, the preferred embodiments are illustrated in the drawings, and a detailed description thereof follows. It is not intended, however, that the invention be limited to the particular embodiments described or to use in connection with the system and method illustrated herein.

### BRIEF DESCRIPTION OF THE DRAWINGS

Various features of the embodiments and the manner of attaining them will be described in greater detail with reference to the following description, drawings and claims, wherein reference numerals are reused, where appropriate, to indicate a correspondence between the referenced items.

FIG. 1 is a schematic illustration showing an exemplary wireless network system of the preferred embodiment.

FIG. 2 is a schematic illustration showing an exemplary Meter page of a pedometer application software running in a wireless network device of the wireless network system of FIG. 1.

FIG. 3 is a schematic illustration showing an exemplary My Profile page of a pedometer application software running in a wireless network device of the wireless network system of FIG. 1.

FIG. 4 is a schematic illustration showing an exemplary Group Setting page of a pedometer application software running in a wireless network device of the wireless network system of FIG. 1.

FIG. 5 is a schematic illustration showing an exemplary Group page of a pedometer application software running in a wireless network device of the wireless network system of FIG. 1.

FIG. 6 is a schematic illustration showing another exemplary Group page of a pedometer application software running in a wireless network device of the wireless network system of FIG. 1.

FIG. 7 is a flowchart diagram showing an exemplary process for a user to upload user data, specify user group, pull to view user group result, and redefine the user group.

### DETAILED DESCRIPTION

The embodiments described herein are directed to the use of wireless or wired network devices to upload data, specify user group and pull in-demand user group characteristics from remote accessible server for reference. Alternatively, the user group characteristics can be sent from remote server to each individual network device regularly. A pedometer application running in smart phone is given as an example to demonstrate the method of specifying user group and providing specified user group characteristics for reference. Refer now to the following description in conjunction with the accompanying figures to describe the features of the embodiments described herein in more detail.

FIG. 1 is a schematic illustration showing an exemplary wireless network system 100 of the preferred embodiment. The wireless network system 100 has a plurality of wireless network devices 110 and 110a-110n and a remote wireless server 120. In the present embodiment, the wireless network devices 110 and 110a-110n are communicated with the remote wireless server 120 through a wireless communication network. In one embodiment, the wireless communication network is a IEEE802.11 wireless local area network. In other embodiments, wideband code division multiple access network, high speed packet access 3G based network, or long term evolution cellular network are used.

The network device 110 has an antenna 115 for transmitting and/or receiving wireless signals. The network device 110 has a modem 111 for modulating and/or demodulating the signals. The network device 110 has a CPU 112 for processing signals and controlling within the network device 110. The network device 110 has a plurality of motion sensors 114. In the present embodiment, the motion sensors comprise an accelerometer, a gyroscope, and a magnetometer. In other embodiments, the motion sensors comprise different combinations of sensors. The network device 110 has a locating device 113. In the present embodiment, the locating device is a global positioning system (GPS). In addition, the network device 110 has a human interface (not shown) for communicating with a user. In one embodiment, the human interface is a screen for accepting user commands and displaying information. In another embodiment, the human interface comprises a keypad.

In the present embodiment, the network device 110 is a smart phone. In another embodiment, the network device 110 is a tablet. Yet in another embodiment, the network device 110 is personal computer.

Each of the network devices 110a-110n can have similar configurations as that of network devices 110.

The remote server 120 has an antenna 124 for transmitting and/or receiving wireless signals. The remote server 120 has a modem 121 for modulating and/or demodulating the signals. The remote server 120 has a CPU 122 for processing signals and controlling within the server 120. The remote server 120 has a storage 123 for storing information sent from network devices 110 and 110a-110n.

The network device 110 can upload its user's personal information to the remote server 120. In the present embodiment, a user's personal information comprises gender, age, race, height, weight, and location. In other embodiments, other combinations of more or less personal information can be included.

The network device 110 can transmit to remote server 120 its user's interested user groups by specifying characters of group parameters. In the present embodiment, group parameters comprise gender, age, race, height, weight, and region. In other embodiments, other combinations of more or less group parameters can be included. Each of the group parameters can be used to form groups. For example, a group can be specified as male, under age 20, White, height over 6 feet, weight over 150 lbs, and locates within 20 miles. Alternatively, more or less group parameters can be combined to form a group. For example, male, over age 50, locates within 100 miles group; female, Asian group; or simply weight over 200 lbs group, etc.

The network device 110 can transmit to the remote server 120 the information collected from the locating device 113, and the motion sensors 114.

Network devices 110a-110n can perform similar processes as described previously in connection with the network device 110.

The remote server 120 then stores and processes the received information from network devices 110 and 110a-110n. In the present embodiment, the remote server 120 processes activity information received from network devices 110 and 110a-110n that are within specified user group, analyzes the received information, and sends analyzed results of group characteristics to network device 110 upon a request from network device 110. Alternatively, the remote server 120 can send the analyzed results of group characteristics to network device 110 in regular basis. In one embodiment, the remote server 120 sends the analyzed results of group characteristics to network device 110 every hour.

FIG. 2 is a schematic illustration showing an exemplary Meter page 200 of a pedometer application software running in the network device 110 of the wireless network system 100 of FIG. 1. As a pedometer, the Meter page 200 displays with walking control and walking information. The Start/Stop key 210 and Reset key 211 can be used to control a pedometer step counter (not shown) to start, stop or reset, respectively. The number of walking step 201 can be obtained by analyzing data collected from motion sensors 114. The walking distance 202, burn calories 203 can be derived from the number of walking step 201 and personal data information of group parameters in My Profile page 300, which will be described in more detail hereafter. The walking duration 204 and walking speed 205 can then be obtained from a process of the CPU 112 of network device 100. The activity information can be uploaded to remote server 120 for storage and analysis. The bottom of the Meter page 200 has page control keys. By touching Meter key 220, Group key 420 or My Profile key 320, a user can switch to associated Meter page 200, Group page 400 or My Profile page 300, respectively.

FIG. 3 is a schematic illustration showing an exemplary My Profile page 300 of a pedometer application software running in the network device 110 of the wireless network system 100 of FIG. 1. A user can provide his/her information of such as name 301-302, gender 303, birth year 304, height 305, weight 306, race 307 and location 308. The information may be used as group parameters to customize the user's interested user group, which will be described in more detail hereafter. By touching the Group Setting key 309, the display leads to Group Setting page 310. The page control keys 220, 320, and 420 shown on the bottom of the My Profile page 300 can perform the same function as described in connection with FIG. 2.

FIG. 4 is a schematic illustration showing an exemplary Group Setting page 310 of a pedometer application software running in the network device 110 of the wireless network system 100 of FIG. 1. A user's interested user group can be customized by specifying the characteristics of the group parameters 301-308 described in My Profile page 300. The Group Setting page 310 of FIG. 4 lists several characteristics of the group parameters.

The gender characteristic 311 can specify either male group, female group, or all (which can be interpreted as not specified).

The age characteristic 312 can specify the age range around the user's age calculated from birth year 304. In the present embodiment, the age group is selected from age range round +/−10, +/−20 of the user's age, or all. In another embodiment, absolute age ranges (e.g., age 21-30, 31-40, . . . ) can be used.

The race characteristic 313 can specify the race group among whites, blacks, Asians, Hispanics, or all.

The height characteristic 314 can specify the range around the user's height 305. In the present embodiment, the height group is selected from height range of +/−0.5, +/−1, +/−1.5 or +/−2 ft around the user's height 305. In another embodiment, absolute height ranges (e.g., height 5′0″ to 5′6″, 5′7″ to 6′, . . . ) can be used.

The weight characteristic 315 can specify the range around the user's weight 306. In the present embodiment, the weight group is selected from weight range of +/−5, +/−10, +/−15 or +/−20 lb around the user's weight 306. In another embodiment, absolute weight ranges (e.g., weight 1301b to 1391b, 1401b to 1501b, . . . ) can be used.

The region characteristic 316 can specify the range around the user's location 308. In the present embodiment, the region group can be within a distance of 20, 100, 500 mile, or global (which can be interpreted as no distance limitation) from the user's location 308.

In the present embodiment, the final user group is the group of users who meet all the specification of the group characteristics 311-316. The final user group can be changed anytime later by going back to the Group Setting page 310 and modifying any of group characteristics 311-316.

Once the final user group is specified, the data of all users within the specified final user group will be analyzed, and the results of user group characteristics will be sent to the user upon request for reference. Alternatively, the results of user group characteristics can be sent to the user in regular basis. The page control keys 220, 320, and 420 shown on the bottom of the Group Setting page 310 can perform the same function as described in connection with FIG. 2.

FIG. 5 is a schematic illustration showing an exemplary Group page 400 of a pedometer application software running in the network device 110 of the wireless network system 100 of FIG. 1. The Group page 400 displays the result of interested data parameter 401 which can be any of parameters such as the number of walking steps 201, walking distance 202, burn calories 203, walking duration 204 and walking speed 205 displayed in the Meter page 200. In the present embodiment, the interested data parameter 401 is the number of walking steps 201. The user's performance 402 of the interested data parameter 401 can be displayed with corresponding performance 403 of specified user group for comparison. In addition the user's performance percentile 404 within the specified user group can be displayed. The comparison can be shown as for one day, one week, and one month. The analyzed data of specified user group can be sent to the user upon request. In the present embodiment, the request is performed by pushing the Group Update key 405. The page control keys 220, 320, and 420 shown on the bottom of the page can perform the same function as described in connection with FIG. 2.

FIG. 6 is a schematic illustration showing another exemplary Group page 410 of a pedometer application software running in the network device 110 of the wireless network system 100 of FIG. 1. In FIG. 6, the user's performance 412 of interested data parameter 401, corresponding performance 413 of specified user group, and the user's performance percentile 414 within the specified user group of past one day, one week or one month are selected by pushing Day key 415, Week key 416 or Month key 417, respectively. In the present embodiment, activity results displayed on Group page 400 or Group page 410 are data form or graphic form.

The embodiments described herein allow the network server 120 to provide performance information 403, 404, 413, 414 of specified user group to the network device 110 without disclosing personal information of users from the specified user group.

FIG. 7 is a flowchart diagram showing an exemplary process for a user to upload user data, specify user group, pull to view user group result, and redefine the user group. A user can first upload the user's information of group parameters such as name, gender, age, height, weight 301-308, and user data such as activity progress to the remote server 120 from the network device 110 via step 500. Then, the user can specify interested user group by specifying characteristics of group parameters 311-316 via step 502. The remote server 120 can then analyze the data of all users among specified user group and then provide user group performance information to the network device 110 without disclosing personal information of users from the specified user group via step 504. The remote server 120 can send the characterized user group characteristics back to the network device 110 upon request (pull on-demand) via step 506. Alternatively, the remote server 120 can send the results to the network device 110 regularly. In step 508, the user can review the group characteristics of specified user group for reference. The user can specify a new user group and view the results by repeating steps 502 to 508 until the user is satisfied with the final results of the new user group.

The process for a user to upload user data, specify user group, pull to view user group result, and redefine the user group described in FIG. 7 can be applicable to any type of processing application and (without limitation) are particularly well suited for wireless applications. The process described herein may be implemented in hardware circuitry, in computer software, or a combination of hardware circuitry and computer software and is not limited to a particular hardware or software implementation.

According to one embodiment, the process can be implemented, in part, in response to a processor (e.g., the CPU 112) executing one or more sequences of one or more instructions contained in a memory (not shown). Such instructions may be read into the memory from a computer-readable storage medium. Execution of the sequences of instructions contained in the memory causes the processor to perform the process steps described herein. One or more processors in a multi-processing arrangement may also be employed to execute the sequences of instructions contained in the memory. In alternative embodiments, hard-wired circuitry may be used in place of or in combination with software instructions to implement the embodiments described herein. Thus, embodiments described herein are not limited to any specific combination of hardware circuitry and software.

The term “computer-readable storage medium” as used herein refers to any medium that participates in providing instructions to processor for execution. Such a medium may take many forms, including non-volatile media and volatile media. Non-volatile media includes, for example, a PROM, an EPROM, a FLASH-EPROM or an optical disk.

Although the present invention has been described in accordance with the embodiments shown, it may be apparent to those skilled in the art that various modifications, variation and improvements of the embodiments described herein may be made in the light of the above teachings and within the purview of the appended claims without departing from the spirit and intended scope of the invention. In addition, those areas in which it is believed that those of ordinary skill in the art are familiar, have not been described herein in order to not unnecessary obscure the embodiments described herein. Accordingly, it is to be understood that the invention is not to be limited by the specific illustrative embodiments.

What is claimed is:

1. A network system, comprising:
a network device, wherein a plurality of user group parameters and characteristics of the group parameters of interested user group are specified and sent to a remote network server; and
a remote network server, wherein the plurality of characteristics of the specified user group are characterized and provided to the network device.

2. The network system of claim 1, wherein both the user group parameters and the characteristics of the group parameters of interested user group can be accessed and modified in the network device on-demand.

3. The network system of claim 1, wherein the network device is a personal communication device.

4. The network system of claim 3, wherein the personal communication device is a smart phone, a tablet or a personal computer.

5. The network system of claim 1, wherein the plurality of group parameters includes gender, age, height, weight, race, and location.

6. The network system of claim 1, wherein the network device uploads quantified user behavior data to the remote network server.

7. The network system of claim 1, wherein the network device has a plurality of motion sensors and a locating device.

8. The network system of claim 7, wherein quantified user behavior data includes the data collected from the motion sensors and locating device of network device.

9. The network system of claim 1, wherein the network server provides the characterized results to the network device without disclosing personal information of users within the specified user group.

10. The network system of claim 1, wherein the characterized results include data and graphic formats.

11. The network system of claim 9, wherein the network server provides the characterized results to the network device on-demand without disclosing personal information of users within the specified user group.

12. The network system of claim 9, wherein the network server provides the characterized results to the network device regularly without disclosing personal information of users within the specified user group.

13. A method for a network system, comprising:
providing a plurality of group parameters from a network device to a remote network server;
specifying a user group by selecting characteristics from each of the plurality of group parameters; and
providing a plurality activity data from the network device to the network server.

14. The method of claim 13, wherein the plurality of group parameters includes gender, age, height, weight, race, and location.

15. The method of claim 13, wherein both the user group parameter and the selected characteristics are accessed and modified according to a specific user command.

16. The method of claim 13, wherein the selected characteristics are characterized in the remote network server, and wherein a group performance information of users from the specified user group is provided to the network device without disclosing personal information of users within the specified user group.

17. The method of claim 16, wherein the characterized performance information include data and graphic formats.

18. The method of claim 16, wherein the group performance information of users from the specified user group is provided to the network device on-demand.

19. The method of claim 16, wherein the group performance information of users from the specified user group is provided to the network device regularly.

20. A computer readable storage medium for a network device comprising an output, the computer readable storage medium carrying one or more sequences of one or more instructions which, when executed by one or more processors, cause the one or more processors to perform the computer-implemented steps of:
providing a plurality of group parameters from a network device to a network server;
specifying a user group by selecting characteristics from each of the plurality of group parameters; and
providing a plurality activity data from the network device to the network server.

21. The computer readable storage medium of claim 20, wherein a group performance information of users from the specified user group is provided to the network device without disclosing personal information of users within the specified user group.

22. The computer readable storage medium of claim 20, wherein the group performance information of users from the specified user group is provided to the network device on-demand according to a specific input signal.
